(19) United States
(12) Patent Application Publication
(10) Pub. No.: US 2012/0149795 A1
(43) Pub. Date: Jun. 14, 2012

(54) POLYURETHANE FOAMS CONTAINING INCORPORATED PHASE CHANGE MATERIAL

(75) Inventors: Stephan Schleiermacher, Pulheim (DE); Heike Niederelz, Leverkusen (DE)

(73) Assignee: Bayer MaterialScience AG, Leverkusen (DE)

(21) Appl. No.: 13/392,450

(22) PCT Filed: Aug. 17, 2010
(86) PCT No.: PCT/EP10/05045

§ 371 Date: Feb. 24, 2012

(30) Foreign Application Priority Data
Aug. 26, 2009 (DE) 10 2009 038 873.7

(51) Int. Cl. C08G 18/06; B32B 3/26; B29C 67/20

(52) U.S. Cl. 521/170; 264/41; 428/316.6

(57) ABSTRACT

The invention relates to polyurethane foams with incorporated phase change material, especially for reinforcing the back of deep-drawn films and components.

The present invention relates to polyurethane foams with latent heat storage units, especially for reinforcing the back of deep-drawn sheets or components.

Polyurethane foams have long been known. They are widely used because of their variably adjustable properties. Thus, foams are found in packaging, furniture and mattresses, in sound and heat insulation, but polyurethanes are also employed in the preparation of solid molded parts, or as a reinforcing coating for deep-drawn thermoplastic sheets.

Such deep-drawn sheets with reinforced backs can be used in a wide variety of applications. On the one hand, they may be used as trim parts in transport vehicles. Thus, hoods or wheel housings of construction machines or agricultural machines can be made of such polyurethane-reinforced sheets. They are also applied in the production of recreational vehicles or caravans. In addition to the exterior trim, they may also be used to produce storage space floors and compartments. Another field of application is in the sanitary field. Thus, bathtubs or washbasins can be stabilized by foam-backing with appropriate polyurethanes.

However, when deep-drawn plastic sheets are foam-backed, the sheet is subject to a high temperature load. The reaction heat during the formation of the polyurethane leads to a softening of the sheet. The sheet consequently loses its smooth surface and becomes uneven. The surface of the product obtained is no longer completely smooth, which becomes evident especially under illumination.

From the prior art, so-called latent heat storage units are known, which can store (reaction) heat by changing their state of matter. Thus, different possible preparations for a wide variety of latent heat storage units are described, for example, by Zhou, X.-M., Journal of Applied Polymers Science, 113 (2009) 2041-2045; Zhou, J. F., et al., Journal of Applied Polymer Science, 102 (2006), 4996-5006; Lee, W. D. et al. Solar Energy Materials and Solar Cells, 91 (2007), 764-768, and Cho, J. S. et al., Colloid and Polymer Science, 280 (2002), 260-266.

These and other latent heat storage units may be employed in connection with polymers for heat storage. DE 10 2004 031 529 A1 describes polyurethane foams with latent heat storage units. The document relates to polyurethane foams obtainable by reacting polyisocyanates with polyols containing encapsulated latent heat storage units, wherein the capsules show a defined particle size distribution.

The polyol is mixed with the latent heat storage units to obtain a corresponding thermoformed foam. Subsequently, the mixture of polyol and latent heat storage units is mixed with the polyisocyanates. Such a polyurethane foam is used, for example, as a cushion material or mattress.

Polyurethane resin foams that may optionally contain isocyanurate structures with encapsulated latent heat storage units are known from DE 10 2004 0449 341 A1. In this case too, the latent heat storage units are mixed with the polyol component of the polyurethane foam. Such a polyurethane rigid foam can be employed, for example, for the heat insulation of cooling appliances, containers or buildings.

From WO 2008/116763 A1, a polyurethane foam comprising from 5 to 70 g of microcapsules per cm³ of foam is known. The microcapsules contain latent heat storage units. Corresponding polyurethane foams are prepared conventionally at first. Subsequently, they are modified by dipping into a solution containing the microcapsules.

From WO 2007/135069 A1, soles having water-absorbing properties are known. The document describes a batch process for preparing a polyurethane foam in which (a) polyisocyanates are mixed with (b) at least one higher molecular weight compound having at least two reactive hydrogen atoms and (c) optionally low molecular weight chain extenders and/or crosslinking agents, (d) blowing agents optionally containing water, (e) catalysts, (f) water-absorbing polymer, (g) optionally latent heat storage units containing capsules, and (h) optionally other additives, and the thus obtained reaction mixture is reacted to a polyurethane foam. In this case too, the latent heat storage units are mixed with a reactant.

A multilayer heat conductive sheet is described by DE 10 2004 039 565 A1. The heat conductive sheet consists of a first layer formed by an electrically insulating and highly elastic elastomer layer with heat-conductive fillers that, as a consequence of its gel properties, can be adapted to the shape and permanently adhered to the uneven surface structure of an electronic circuit. The second layer, which is substantially thinner than the first layer, is firmly bonded to the first layer, the second layer being formed as a PCM layer applied to the first layer, which is thinned out and/or undergoes a change of its state of matter under the influence of pressure and/or temperature when a heat sink or housing element is applied thereto. Thus, a latent heat storage unit is known not only in the form of capsules, but also as a mat or comparable sheet-like structures.

Latent heat storage units are known not only in polymeric foams, but also in other materials. Thus, DE 10 2004 041 298 A1 describes a composite element made of polyurethane rigid foam. The latent heat storage units are contained in the cover layers surrounding the polyurethane rigid foam.

Thus, a polyurethane foam with latent heat storage units is described in the prior art. However, the latent heat storage units are incorporated only into the finished polyurethane product, for example, the mattress. Alternatively, the latent heat storage units are admixed to the polyol. This has the disadvantage that the complete product contains the latent heat storage units. Thus, it is required in a large amount even if this is not necessarily required on a local level. To stabilize the mixture of polyol and latent heat storage units, it is required that the polyol component be permanently stirred lest the latent heat storage units should deposit on the bottom of the storage tank. Further, there is also a risk that the latent heat storage units clump together. In this case, a uniform distribution in the foam is no longer ensured. Also, the latent heat storage units can occlude the conduits or the mixing head in which the polyol and polyisocyanate are mixed, or destroy them in some other way.

One disadvantage resulting from the prior art is the fact that the latent heat storage units are distributed throughout the polyurethane foam. However, the latent heat storage units are preferentially required in particular regions, for example, near the surface. It is desirable, however, that additives be present only in those regions where their presence is required. With the process of the prior art, this would be possible only if two polyurethane foams were prepared separately, one containing the latent heat storage units, the other not.

Thus, it is the object of the present invention to selectively add latent heat storage units to a polyurethane foam in defined regions, avoiding the disadvantages of the prior art. Such a polyurethane foam can then be used, for example, for foam-backing plastic sheets without the sheets becoming soft from the reaction heat of the polyurethane and thus get an uneven surface.

Thus, it is another object of the present invention to optimize the use of the latent heat storage units so that these latent heat storage units are present predominantly in those regions of the polyurethane foam where their presence is required. This leads to a reduced amount of the latent heat storage units required. Further, it should be possible to adjust the extent of latent heat storage selectively and variably by the kind and quantity of the latent heat storage units.

In a first embodiment, the above object is achieved by a polyurethane foam with latent heat storage units wherein the mass proportion of the latent heat storage units, based on the mass of the polyurethane matrix, in a defined volume region is larger than the mass proportion of these latent heat storage units in a volume region remote from said defined volume region.

A preferred embodiment comprises a polyurethane foam containing latent heat storage units, especially for foam-backing a shell, wherein the proportion of the latent heat storage units in a defined volume region is larger than the proportion of these latent heat storage units in a volume region remote from said defined volume region.

For example, a defined volume region may be a surface region that comes into direct contact with a shell to be foam-backed. In addition, it is also possible that the defined volume region is in the interior of the polyurethane foam.

For example, deep-drawn plastic sheets serve as the shell. Such sheets are usually prepared on the basis of acrylonitrile-butadiene-styrene (ABS), poly(methyl methacrylate) (PMMA), acrylonitrile-styrene-acrylic ester (ASA), polycarbonate (PC), thermoplastic polyurethane, polypropylene (PP), polyethylene (PE) and/or polyvinyl chloride (PVC). It may also be a two-layer sheet, the first layer being based on PC and the second layer on ABS, for example.

The outer layer may also include so-called in-mold coatings or gel coats. In-mold coating is a method by which the paint coating of a plastic molded part is performed already in the mold. Thus, a highly reactive two-component paint is placed into the mold by means of a suitable paint coating technique. Subsequently, the polyurethane is introduced in the open or closed mold.

A structure according to the invention of a polyurethane foam containing latent heat storage units requires an accumulation of the latent heat storage units in a defined volume region of the polyurethane foam, for example, in the region that comes into contact with the shell. Thus, latent heat storage units are predominantly or exclusively present in the regions where they are needed. In this context, “proportion of the latent heat storage units in a defined volume region” means the mass and/or volume proportion of the latent heat storage units in a defined, but variable volume.

Being a non-reinforcing filler, the latent heat storage units deteriorate the mechanical properties of the polyurethane. Consequently, only a limited use thereof is allowed in the regions where its particular thermal properties are needed, or in other words, it must be omitted in other regions in order to reduce losses of mechanical properties.

The process for preparing the polyurethane foam, which will be discussed in more detail below, enables the foam to be designed in such a way that the proportion of the latent heat storage units increases continuously or discontinuously towards its surface. For example, “surface” means the layer that is directly adjacent to the shell. A “discontinuous increase” means increases that are abrupt in a way, in which regions containing different proportions of latent heat storage units can be distinguished; however, these regions themselves need not have been produced discontinuously. Conversely, for a continuous increase of the proportion of latent heat storage units, it is also possible to produce different regions or layers discontinuously, however, without a distinctive (for example, visual) delimitation between them.

It is further preferred that the polyurethane foam according to the invention comprises at least two full-area or partial-area layers of the same or different foam compositions that differ at least in the proportion of the latent heat storage units.

It is easy to see that such a gradient structure is useful for achieving a better adaption to the actual problems.

Further, it is possible that the polyurethane foam comprises at least one or more surface layers containing latent heat storage units, and at least one layer that is free of latent heat storage units.

The layer provided with the latent heat storage units within the polyurethane foam preferably has a thickness of at least 0.1 mm, especially 0.5 mm. This minimum layer thickness is necessary for a sufficient amount of latent heat storage units to be available to absorb the reaction heat of the polyurethane and thus also to obtain a smooth surface of the deep-drawn sheets. The maximum layer thickness depends on the total layer thickness of the polyurethane foam and the required heat capacity of the layer comprising the latent heat storage units, especially a maximum of ⅘ of the total layer thickness, preferably a maximum of ⅓ of the total layer thickness.

When further layers are applied, more reaction heat must be absorbed by the latent heat storage units accordingly, so that a larger proportion becomes necessary.

Further, according to the invention, it is possible that the whole surface region does not comprise the latent heat storage units. Rather, according to the present invention, it is preferred that only a defined region of the surface is equipped with such units, namely the region where the sheets will be visible to the user later. This results to a further saving of the required latent heat storage units.

Materials having a solid state of matter at room temperature are suitable as latent heat storage units. Then, at temperatures produced by the reaction heat of the polyurethane, the corresponding materials should change their state of matter and undergo a transition, for example, to a liquid state. Suitable latent heat storage materials usually include lipophilic substances that have a solid/liquid phase transition in a temperature range of from 0 to 150° C., especially from 20 to 90° C. A more preferred temperature range is from 21 to 70° C.

The following may be mentioned as examples of suitable substances:
aliphatic hydrocarbon compounds, such as saturated or unsaturated C₁₀ to C₅₀ hydrocarbons that are branched or preferably linear, for example, n-hexadecane, n-octadecane, n-eicosane, as well as cyclic hydrocarbons, for example, cyclodecane;
aromatic hydrocarbon compounds, such as benzene, naphthalene, C₁- to C₄₀-alkyl substituted aromatic hydrocarbons, such as dodecylbenzene, tetradecylbenzene, or decylnaphthalene;
saturated or unsaturated C₆ to C₃₀ fatty acids, such as lauric, stearic, oleic or behenic acids, preferably eutectic mixtures of decanoic acid with, for example, myristic, palmitic or lauric acid;
fatty alcohols, such as lauryl, stearyl, oleyl, myristyl, cetyl alcohol;
C₆ to C₃₀ fatty amines, such as decylamine, dodecylamine, tetradecylamine or hexadecylamine;
esters, such as C₁ to C₁₀ alkyl esters of fatty acids, such as propyl palmitate, methyl stearate or methyl palmitate, and preferably eutectic mixtures thereof;
natural and synthetic waxes, such as montanic acid waxes, montanic ester waxes, carnauba wax, polyethylene wax, oxidized waxes, polyvinyl ether wax, ethylene/vinyl acetate wax or hard waxes obtained by the Fischer-Tropsch process;
halogenated hydrocarbons, such as chloroparaffin, bromooctadecane, bromopentadecane, bromononadecane, bromoeicosane, bromodocosane;
low melting salts of the above mentioned acids.

Preferably, the latent heat storage units are in an encapsulated form. The capsule generally contains polymers, especially thermoset materials, for example, formaldehyde resins, polyureas and polyurethanes, as well as highly crosslinked methacrylic acid ester polymers.

In another embodiment, the object of the invention is achieved by a process for preparing a polyurethane foam as defined above in which latent heat storage units are incorporated in a reaction mixture of polyol component and isocyanate component, the thus obtained mixture is employed, in particular, for foam-backing deep-drawn plastic sheets, characterized in that the ratio R of the amount of incorporated latent heat storage units to the amount of the reaction mixture is constant within a defined time period of incorporating, but is different from this ratio in a subsequent second time period of incorporating the reaction mixture.

In this connection too, the term “amount” may refer to a quantity defined by either mass or volume.

The two time periods for forming the gradient of the latent heat storage units in the polyurethane foam, on which the comparison is based, have equal lengths. In contrast, the length of the two (equal length) time periods is not limited in the present invention, i.e., can be chosen arbitrarily.

A “comparison or two time periods” does not necessarily mean that the time periods used for the comparison must be within the same process for forming the foam (for example, applying a PUR raw material). The term may also refer to (equal length) time periods in different application processes (for example, application of a PUR jet containing latent heat storage units on one side, followed by application of a PUR jet free of latent heat storage units on the other side of the polyurethane foam molded part).

Since the ratio R of the amount of incorporated latent heat storage units to the amount of the foam raw material can be chosen at will (possibly within particular limits), polyurethane foams with quite different distributions of latent heat storage units within the polyurethane foam can be realized.

Using a process according to the invention, almost any geometry can be realized, i.e., the latent heat storage units can be employed much more efficiently.

Further, the preparation can be effected wet on wet. This means that, when several layers are applied, one does not or need not wait until the PUR material applied in a previous layer has completely cured. No additional operation for preparing a finished interior core is required, and thus the PUR formulation can be processed in one operation when the corresponding technology is used.

Thus, it is possible to apply one or more layers of polyurethane containing less latent heat storage units or none at all to the first layer containing the latent heat storage units, which is adjacent to the sheet, for example. It is not required to dry or crosslink the first layer. In addition to the modification of the layer thickness and the proportion of latent heat storage units contained therein, the composition of the polyurethane may also be varied.

Further, it is possible to supply usual additives, such as flame retardants, or fibers to the polyurethane during the preparation thereof. Further, the mixing ratio of polyol and isocyanate may also be changed.

As components for the preparation of the polyurethane foam, polyols and isocyanates that are well-known in the prior art are employed.

In this process, it is preferred that the jet containing the latent heat storage units is directed into the reaction jet of the foam raw material, or that a reaction jet of the foam raw material is directed into the jet containing the latent heat storage units. Alternatively, it is of course also possible to bring a jet of the latent heat storage units in contact with a spraying jet. The mutual incorporation of the mutual materials reaches an optimum crosslinking of the solid with the advantages described above. In addition, a step of mixing the latent heat storage units into a liquid foam raw material can be dispensed with. This avoids the above described disadvantages, in particular, a constant mixing of the raw materials is not required. In addition, the setting of the temperature, viscosity of the foam raw materials etc. is not affected.

Particularly preferred is a process in which the gas flow or flows containing the solid are not metered into the already dispersed spray jet of the reaction mixture, but injected into the non-dispersed jet while still liquid within the mixing chamber of the mixing head.

According to the invention, a “liquid jet of a PUR reaction mixture” means such a fluid jet of a PUR material, especially in the region of a mixing chamber for mixing the reaction components in a liquid form, which is not yet in the form of fine droplets of reaction mixture dispersed in a gas flow, i.e., especially in a liquid viscous phase.

The processes of the prior art essentially utilize a gas flow or a corresponding nozzle for atomizing a PUR reaction mixture and meter a solid-containing gas flow into such an atomized PUR spray jet. For any spray jet, and also in this case, it holds that the distance between neighboring spray particles orthogonal to the main spraying direction of a spray jet increases as the distance from the spray nozzle increases. The probability that solid particles collide with polyurethane droplets or already wetted filler particles and are wetted thereby is inevitably quickly decreasing. The situation changes if the mixing of fillers and polyurethane is effected in a mixing chamber according to the process of the invention.

The device is characterized in that solids are directed by a conveying gas flow into a mixing chamber, where they hit a liquid jet of a PUR reaction mixture. The gas flows with solids are allowed to collide in the mixing chamber by letting them enter the mixing chamber through two or more points. Neighboring spray jets can form large angles with one another and be perpendicular to a circular circumferential line of the cylindrical mixing chamber. They thus collide in the imaginary center axis of the mixing chamber. However, they may also be injected tangentially and form a vortex that defines a circle that is orthogonal to the main direction of flow in the mixing chamber. In the process according to the invention, the particles cannot escape each other or move away from each other because the walls of the mixing chamber prevent this. Therefore, solids are forcibly wetted with the PUR reaction mixture with no losses in the interior of the mixing chamber in the process according to the invention and thus become part of a homogeneous gas/solid/PUR material mixture.

Preferably, the mixing quality of the resulting gas/solid/PUR material mixture in the mixing chamber is again enhanced by additional air vortices. The air vortices are produced by air from tangential air nozzles. The circular areas surrounded by them form a right angle with the axis of the main direction of flow in the mixing chamber.

Another advantage of the process according to the invention resides in the fact that no expenditure relating to agitation in storage vessels and no specialized pumping technology for encapsulated products are required. The latter can be metered gently into the mixing chamber. Clumping, aggregation and floating or sinking of latent heat storage units in the day tank cannot occur. In addition, the later metering of the latent heat storage units into the reaction jet prevents the danger of damage to the pumps, mixing heads and nozzles from the latent heat storage units.

For an even better interconnection between the latent heat storage units and the foam raw material, it is particularly preferred that the latent heat storage units and the foam raw material are used to foam-back deep-drawn sheets.

A further preferred process variant is characterized in that a corresponding sheet is placed into a molding die, especially a mold, and the polyurethane foam containing the latent heat storage units is applied thereto. To this is then applied another foam material that contains no latent heat storage units or has a lower proportion of latent heat storage units. Such a discontinuous application of different layers with different latent heat storage units greatly simplifies the process.

In another embodiment, the object of the present invention is achieved by the use of the sheet foam-backed with a polyurethane foam according to the invention as a trim part in transport vehicles. According to the invention, such a construction part may also be employed for paneling or separating in recreational vehicles or caravans. Further, a corresponding polyurethane foam may also be employed for reinforcing sanitary objects, such as bathtubs.

A particular embodiment of the invention consists of a particular sequence of layers, for example:

PUR/PIR+latent heat storage units/PUR

This embodiment is of advantage, in particular, when non-encapsulated waxes, for example, are employed, which are prevented by the exterior PUR layers from migrating to the surface.

The present invention is also advantageous for the preparation of insulation spraying foam. For example, when the foam is inserted on the inside of a room and the wax-PUR layer is close to the surface, it can quickly absorb excess heat. The heat energy need not first permeate the insulating PUR foam. Conversely, when the room temperature falls below the target temperature, the PUR layer with the latent heat storage units faces towards the room and can quickly provide the stored heat energy. In addition, the PUR layer with the latent heat storage units is itself insulated by “unfilled” PUR on the backside, so that little heat flows “into the wrong direction”.

It is similar with flexible molded foams. If the wax is only in an exterior layer, the mechanical properties of the foam are little affected. At the same time, the proximity of the heat source (i.e., the human) ensures that the desired temperature buffering is provided quickly.

### EXAMPLES

In experiments 1 to 11, different latent heat storage units in amounts of from 5 to 10% by weight, based on the polyurethane, were mixed with the polyol components and the isocyanate in the beaker, and stirred for 10 seconds. Table 1 shows the respective compositions. A temperature sensor was placed so that its measuring point contacted the surface of a PE plate. The liquid reaction mixture was poured onto the measuring point of the temperature sensor. The liquid reaction mixture was spread to a layer thickness of 2 mm. The temperature of the sensor was determined in times of from 30 sec to 180 sec as measured from the time of mixing. The measuring results are shown in Table 2.

TABLE 1
The polyols and isocyanate are stated in weight parts.

| | Experiment | 01 | 02 | 03 | 04 | 05 | 06 | 07 | 08 | 09 | 10 | 11 |
|---|---|---|---|---|---|---|---|---|---|---|---|---|
| | Polyol 1 | 80.00 | 80.00 | 80.00 | 80.00 | 80.00 | 80.00 | 80.00 | 80.00 | 80.00 | 80.00 | 80.00 |
| | Polyol 2 | 20.00 | 20.00 | 20.00 | 20.00 | 20.00 | 20.00 | 20.00 | 20.00 | 20.00 | 20.00 | 20.00 |
| | Isocyanate | 137.32 | 137.33 | 137.33 | 137.33 | 137.33 | 137.33 | 137.33 | 137.33 | 137.33 | 137.33 | 137.33 |
| | | 561 | | | | | | | | | | |
| Fillers | Latent heat | | 5.00 | 10.00 | | | | | | | | |
| (percent by | storage | | | | | | | | | | | |
| weight, based on | units 1 | | | | | | | | | | | |
| PUR) | Latent heat | | | | 5.00 | 10.00 | | | | | | |
| | storage | | | | | | | | | | | |
| | units 2 | | | | | | | | | | | |
| | Latent heat | | | | | | 5.00 | 10.00 | | | 10.00 | |
| | storage | | | | | | | | | | | |
| | units 3 | | | | | | | | | | | |
| | Latent heat | | | | | | | | 5.00 | 10.00 | | |
| | storage | | | | | | | | | | | |
| | units 4 | | | | | | | | | | | |

Description of the starting materials:
Polyol 1: A commercially available amine-initiated tetrafunctional PO polyether with an OH number of 630.
Polyol 2: A commercially available trifunctional EO polyether with an OH number of 255.
Isocyanate: An isocyanate with an NCO content of about 32% by weight, prepared on the basis of 2-ring MDIs and their higher homologs.
Latent heat storage units 1: esters of montanic acids C24-C34, such as Licowax KST from Clariant
Latent heat storage units 2: mixture of wax acids C24-C34, such as Licowax NC FL from Clariant
Latent heat storage units 3: esters of montanic acids C24-C34, such as Licowax EP from Clariant
Latent heat storage units 4: esters of montanic acids C24-C34, such as Licowax E FL from Clariant

TABLE 2

| Experiment | 1 | 2 | 3 | 4 | 5 | 6 | 7 | 8 | 9 | 10 | 11 |
|---|---|---|---|---|---|---|---|---|---|---|---|
| Filler | — | Licowax | Licowax | Licowax | Licowax | Licowax | Licowax | Licowax | Licowax | Licowax | — |
| | | KST | KST | NC FL | NC FL | EP | EP | E FL | E FL | EP | |
| Filler in % | — | 5 | 10 | 5 | 10 | 5 | 10 | 5 | 10 | 10 | — |
| by weight | | | | | | | | | | | |
| Filler | | powder | powder | fine | fine | powder | powder | fine | fine | powder | |
| shape | | | | flakes | flakes | | | flakes | flakes | | |
| Note: | with no | | | | | | | | | 2 layers | 2 layers |
| | filler | | | | | | | | | 1st layer | 1st layer |
| | | | | | | | | | | with filler | with no |
| | | | | | | | | | | 2nd layer | filler |
| | | | | | | | | | | with no | 2nd layer |
| | | | | | | | | | | filler | with no |
| | | | | | | | | | | | filler |

Temperature measurement after

| | | | | | | | | | | | |
|---|---|---|---|---|---|---|---|---|---|---|---|
| 30 sec [° C.] | 54.0 | 47.7 | 46.0 | 53.4 | 50.1 | 40.1 | 37.0 | 42.8 | 40.5 | | |
| 40 sec [° C.] | 70.0 | 59.7 | 52.0 | 66.2 | 62.0 | 45.8 | 42.0 | 53.0 | 47.8 | | |
| 50 sec [° C.] | 90.6 | 74.0 | 56.0 | 77.0 | 67.3 | 53.2 | 44.3 | 63.2 | 53.7 | | |
| 60 sec [° C.] | 100.1 | 85.4 | 60.0 | 82.5 | 71.8 | 59.4 | 46.0 | 70.8 | 58.8 | 66.0 | 84.5 |
| 70 sec [° C.] | 100.4 | 91.2 | 63.7 | 83.9 | 73.8 | 64.0 | 49.0 | 76.5 | 61.7 | 70.3 | 85.9 |
| 80 sec [° C.] | 96.8 | 92.3 | 65.4 | 82.6 | 74.7 | 66.3 | 51.0 | 79.3 | 63.7 | 72.0 | 94.4 |
| 90 sec [° C.] | 92.7 | 90.7 | 65.8 | 80.0 | 74.3 | 67.0 | 52.2 | 79.3 | 64.0 | 78.2 | 105.5 |
| 100 sec [° C.] | 88.0 | 87.8 | 64.0 | 77.0 | 72.9 | 66.2 | 52.6 | 77.8 | 63.3 | 85.3 | 114.7 |
| 110 sec [° C.] | 84.2 | 84.1 | 63.6 | 74.1 | 71.3 | 65.2 | 52.2 | 75.6 | 62.1 | 90.9 | 118.4 |
| 120 sec [° C.] | 80.5 | 81.1 | 62.5 | 71.4 | 69.7 | 63.2 | 51.2 | 73.2 | 60.6 | 94.7 | 119.0 |
| 130 sec [° C.] | | | | | | | | | | 96.7 | 117.9 |
| 140 sec [° C.] | | | | | | | | | | 96.8 | 115.9 |
| 150 sec [° C.] | 71.9 | 72.2 | 57.0 | 64.3 | 64.8 | 57.5 | 47.8 | 66.4 | 56.0 | 95.9 | 113.2 |
| 160 sec [° C.] | | | | | | | | | | 94.2 | 110.8 |
| 170 sec [° C.] | | | | | | | | | | 92.2 | 108.1 |
| 180 sec [° C.] | 65.7 | 66.0 | 52.4 | 59.1 | 60.3 | 52.8 | 44.8 | 61.1 | 51.8 | 90.0 | 105.4 |

Experiment 1 is comparative, Experiments 2 to 10 according to the invention show that the peak temperature reached of the reaction mixture is variable and can be significantly decreased as compared to the standard, depending on the type of wax and the amount of wax employed.

Experiment 11, which is not according to the invention, shows the course of temperature on the PE surface if a second PUR layer is applied to a first one within 30 sec. The material reaches higher peak temperatures as compared to experiment 1. Experiment 10 according to the invention shows that the use of the latent storage units only in the lower layer is sufficient to decrease the course of the temperature as compared to experiment 11. This experiment illustrates the fact that it is sufficient to protect only the contact surface with a thermally sensitive material by latent heat storage units. Regions more remote from the thermally relevant region may contain less latent heat storage units or none at all.

1. A polyurethane foam with latent heat storage units, in which the mass proportion of the latent heat storage units, based on the mass proportion of the polyurethane matrix, in a defined volume region is larger than the mass proportion of these latent heat storage units in a volume region remote from said defined volume region.

2. The polyurethane foam according to claim 1, characterized in that the proportion of the latent heat storage units increases continuously or discontinuously from a point in the interior region in at least one direction towards the surface of the body.

3. The polyurethane foam according to claim 1, characterized by comprising at least two full-area or partial-area layers of the same or different foam compositions that differ at least in the mass proportion of the latent heat storage units.

4. The polyurethane foam according to claim 3, characterized by comprising at least one surface region containing latent heat storage units, and at least one layer that is free of latent heat storage units.

5. The polyurethane foam according to claim 1, characterized in that said volume region enriched with latent heat storage units has a layer thickness of at least 0.1 mm.

6. The polyurethane foam according to claim 1, characterized in that said latent heat storage materials have a solid/liquid phase transition in a temperature range of from 0 to 150 ° C., especially from 20 to 90° C., particularly in a temperature range of from 21 to 70° C.

7. The polyurethane foam according to claim 6, characterized in that said latent heat storage materials include natural and/or synthetic waxes.

8. The polyurethane foam according to claim 6, characterized in that said latent heat storage materials are within a capsule, preferably a thermoset capsule.

9. A process for preparing a polyurethane foam according to claim 1, in which latent heat storage units, especially encapsulated ones, are incorporated in a reaction mixture of polyol component and isocyanate component, the thus obtained mixture is employed, in particular, for foam-backing deep-drawn plastic sheets, characterized in that the ratio R of the amount of incorporated latent heat storage units to the amount of the reaction mixture is constant within a defined time period, but is different from this ratio in a subsequent second time period.

10. The process according to claim 9, wherein a jet containing the latent heat storage units is directed into the reaction jet of the foam raw material, or a reaction jet of the foam raw material is directed into a jet containing the latent heat storage units.

11. The process according to claim 9, characterized in that said latent heat storage units and said foam raw material are sprayed into an open mold.

12. The process according to claim 11, characterized in that a foam layer containing said latent heat storage units is placed first in a mold, and a foam raw material containing less latent heat storage units or none at all is applied thereto.

13. Use of a polyurethane foam according claim 1 for the foam-backing of plastic sheets.

14. Use of a deep-drawn plastic sheet according to claim 13 as a trim part in transport vehicles.
